(19) United States
(12) Patent Application Publication
(10) Pub. No.: US 2025/0297634 A1
(43) Pub. Date: Sep. 25, 2025

(54) UNIVERSAL VALVE MOUNTING ASSEMBLY

(71) Applicant: Bradford M. Daniels, Myrtle Beach, SC (US)

(72) Inventor: Bradford M. Daniels, Myrtle Beach, SC (US)

(21) Appl. No.: 18/612,471

(22) Filed: Mar. 21, 2024

(51) Int. Cl. F16B 35/00; F16B 35/04

(52) U.S. Cl. CPC F16B 35/005; F16B 35/041

(57) ABSTRACT

A universal control valve mounting assembly includes a crossmember traversing between opposing studs within a wall, the crossmember secured at opposing ends to the opposing studs via end brackets having apertures formed therethough. The assembly further includes a support plate coupled to the crossmember and laterally adjustable along the length of the crossmember, the support plate having a plurality of perforations. The assembly also includes a set screw coupling the support plate to the crossmember, the set screw penetrating at least one perforation and mechanically engaging the crossmember.

### I. RELATED APPLICATIONS

There are no previously filed, nor currently any co-pending applications, anywhere in the world.

### II. FIELD OF THE INVENTION

The present application discloses claims and embodiments generally related to plumbing mounting installations, and in particular, a universal control valve mounting assembly.

### III. BACKGROUND OF THE INVENTION

Currently there exist in the art numerous plumbing mounting units and apparatuses for the installation of water flow valves for plumbing fixtures such as sinks, bathtubs, showers, and toilets. Although not exhaustive, the references provided hereinbelow serve as a representation of the improvements in such apparatuses and assemblies.

U.S. Pat. No. 7,210,493 B1, issued in the name of Wang, wherein Wang discloses a mounting apparatus for a faucet assembly that includes a mounting plate and a backing plate that clampingly attach to a surface such as a sink, bathtub, countertop or shower wall. Wang teaches the shower vertical surface 12 is sandwiched and clamped by the mounting plate 25 and backing plate 6. (See Col. 3, lines 24-26, and FIG. 9).

U.S. Pat. No. 6,076,204, issued in the name of Mullick, wherein Mullick discloses bathtub/shower bathing units customized to accommodate the requirements of users having limited locomotive ability, aged persons, and persons requiring assistance in bathing. Mullick further discloses a panel 52 with a plate 58having extended ends with holes through which screws 60 are passed to secure panel 10 to the frame 10. (See Col. 6, lines 33-43).

U.S. Pat. No. 4,457,031, issued in the name of Moore, wherein Moore discloses a modular, pre-plumbed shower unit is of self-contained nature facilitating rapid shower installation, and includes a plumbing tree including conduits interconnecting a shower head fixture, a tub spout, and control valve for controlling hot and cold water flow to the shower head or tub spout. Resilient pinch mounting brackets secure the plumbing tree to an exterior wall surface. Water supply connections to the control valve are made outside of the wall through an opening therein. A pre-molded shell is secured to the plumbing tree to surround and conceal the plumbing tree in overlying relationship to the wall.

U.S. Pat. No. 3,443,266, issued in the name of Mongerson et al., wherein Mongerson et al. discloses a plumbing fixture and means for mounting the fixture. In particular, the invention relates to a bathtub combination plumbing fixture that may include (as an integral part of the fixture) a grab bar or hand grip, a mixing valve and a control member therefor, a soap dish, a spout for water discharge into the tub, and a diverter for controlling water flow to the spout or shower. The mounting for the plumbing fixture is formed by means of a mounting plate, positioned on the opposite side of the wall surface from the utilitarian and decorative portions of the plumbing fixture.

U.S. Pat. No. 1,835,301, issued in the name of Hennessey, wherein Hennessey provides means by which the installation of plumbing fixtures in both old and new walls, and especially the former may be accomplished in a simple and expeditious manner, and whereby the necessary wall apertures may be covered without requiring additional plastering or tile work. Although the invention relates more particularly to bath installations, it also is applicable to other plumbing installations, such as those including lavatories, sinks and the like. To facilitate the economical insertion of piping and valve means within a wall of either a new or an old build by providing an apertured panel for 113 adequately covering a recess made in the wall for the piping and valve means, the panel obviating the necessity of finishing or-refinishing the wall over and adjacent the wall recess.

U.S. Pat. No. 6,609,774 B2, issued in the name of Banicevic et al., wherein Banicevic et al. discloses a refrigerator with a pull out drawer has plastic cabinet and drawer liners and a closed reinforcing assembly mounted within the drawer and cabinet for supporting loads carried by the drawer. The assembly has a reinforcing brace secured within the drawer having two spaced apart wing members and a cross member connected to and extending between the wing members adjacent an inside surface of the inner liner. The assembly has a pair of telescopically extendable guide rails each mounted to one of the opposing liner side walls of the cabinet and the through the liner of the drawer to support the drawer for relative movement with the cabinet. The cabinet has a pair of reinforcing bracket members located therein each having a side reinforcing portion extending adjacent a corresponding one of the guide rails and mounted to the liner side wall by fasteners passing through the guide rails and liner side walls. The reinforcing bracket members each having a rear wall portion extending orthogonal from the respective side reinforcing portions adjacent to and in contact with the rear wall of the interior liner secured to each other to form a continuous arm to interconnect and reinforce the side reinforcing portions. The closed reinforcing assembly comprising the reinforcing brackets, the guide rails and the reinforcing brace provide a closed loop rectangular reinforcing structure for loads carried by the guide rails and drawer.

Accordingly, a need continues to exist and is recognized for improvements to control valve assemblies.

This application presents claims and embodiments that fulfill a need or needs not yet satisfied by the products, inventions, systems, and methods previously or presently available. In particular, the claims and embodiments disclosed herein describe a universal control valve mounting assembly, the assembly comprises a crossmember traversing between opposing studs within a wall, the crossmember secured at opposing ends to the opposing studs via end brackets having apertures formed therethough; a support plate coupled to the crossmember and laterally adjustable along a length of the crossmember, the support plate comprising a plurality of perforations; and a set screw coupling the support plate to the crossmember, the set screw penetrating at least one perforation and mechanically engaging the crossmember, the assembly providing unanticipated and nonobvious combination of features distinguished from the products, devices, apparatuses, inventions, systems, and methods preexisting in the art. The applicant is unaware of any device, apparatus, method, system disclosure or reference that discloses the features of the claims and embodiments disclosed herein.

### IV. SUMMARY OF THE INVENTION

In accordance to one embodiment, a universal control valve mounting assembly comprises a crossmember traversing between opposing studs within a wall, the crossmember secured at opposing ends to the opposing studs via end brackets having apertures formed therethough. The assembly includes a support plate coupled to the crossmember and laterally adjustable along the length of the crossmember, the support plate comprising a plurality of perforations. The assembly also includes a set screw coupling the support plate to the crossmember, the set screw penetrating at least one perforation and mechanically engaging the crossmember.

In accordance with another embodiment, a universal control valve mounting assembly comprises a crossmember traversing between opposing studs within a wall, the crossmember secured at opposing ends to the opposing studs via end brackets having apertures formed therethough. The assembly also includes a support plate coupled to the crossmember and laterally adjustable along the length of the crossmember, the support plate coupled to the crossmember via a sleeve disposed on the reverse surface of the support plate, support plate comprising a plurality of perforations. The assembly also includes a set screw coupling the support plate to the crossmember, the set screw penetrating at least one perforation and mechanically engaging the crossmember.

In accordance to still another embodiment, another embodiment, a universal control valve mounting assembly comprises a crossmember traversing between opposing studs within a wall, the crossmember secured at opposing ends to the opposing studs via end brackets having apertures formed therethough. The assembly also includes a support plate coupled to the crossmember and laterally adjustable along the length of the crossmember, support plate comprising a plurality of perforations. The assembly also includes a sleeve disposed along a reverse surface of the support plate, the sleeve comprising an interior dimension complementary to the exterior dimension of the crossmember; and a set screw coupling the support plate to the crossmember, the set screw penetrating at least one perforation and mechanically engaging the crossmember.

In the described embodiments, one or more crossmembers are utilized.

In the described embodiments, each crossmember utilized comprises a plurality of indicia designating length and scored for removing a defined segment of the crossmember.

In the described embodiments, one or more sleeves are utilized.

In the described embodiments, each sleeve includes an interior dimension complementary to the exterior dimension of the crossmember(s) accommodated by the sleeve(s).

In the described embodiments, each one of the brackets may further comprise a recess supporting the end of the crossmember, the recess having at least one open side.

In the described embodiments, each one of the brackets the

may further comprise a recess supporting the end of crossmember, the recess closed on all sides.

### V. BRIEF DESCRIPTION OF THE DRAWING(S)

The advantages and features of the present invention will become better understood with reference to the following more detailed description and claims taken in conjunction with the accompanying drawings, in which like elements are identified with like symbols, and in which:

FIG. 1 is a front view of the assembly with the support plate carried on a single elevation of the crossmember(s), in accordance to one embodiment of the present invention;

FIG. 2 is a front view of the assembly, an alternative configuration to FIG. 1, with the support plate carried on a double elevation of the crossmembers;

FIG. 3 is a front view of the crossmember illustrating the indicia along the length of the shaft or bar of the crossmember;

FIG. 4A is a side view of the support plate;

FIG. 4B is a side view of the support plate illustrating an orthogonally shaped sleeve intermediate to the top and bottom margins of the support plate;

FIG. 4C is a side view of the support plate illustrating a cylindrically-shaped sleeve;

FIG. 4D is a side view of the support plate illustrating a triangularly-shaped sleeve;

FIG. 4E is a side view of the support plate illustrating a top sleeve and bottom sleeve configuration, with the top sleeve adjacent the top margin of support plate and the bottom sleeve adjacent the bottom margin of support plate;

FIG. 5A is a perspective view of the bracket in the form of an extended panel with an aperture;

FIG. 5B is a side view of an alternative bracket with a recess having an open side;

FIG. 5C is a side view of an alternative bracket with a recess having no open side and all closed sides;

FIG. 6A is a front view of a crossmember with end brackets removably attached at opposed ends respectively thereof, in accordance to another embodiment of the present invention;

FIG. 6B is a front elevational view of an end bracket in accordance to an alternate embodiment of the present invention; and

FIG. 6C is a left side elevational view of the end bracket shown in FIG. 6B.

### VI. DESCRIPTION OF THE EMBODIMENT(S)

It will be readily understood that the components of the present invention, as generally described and illustrated in the figures herein, may be arranged and designed in a wide variety of different configurations. Thus, the following detailed description of the embodiments, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present invention. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

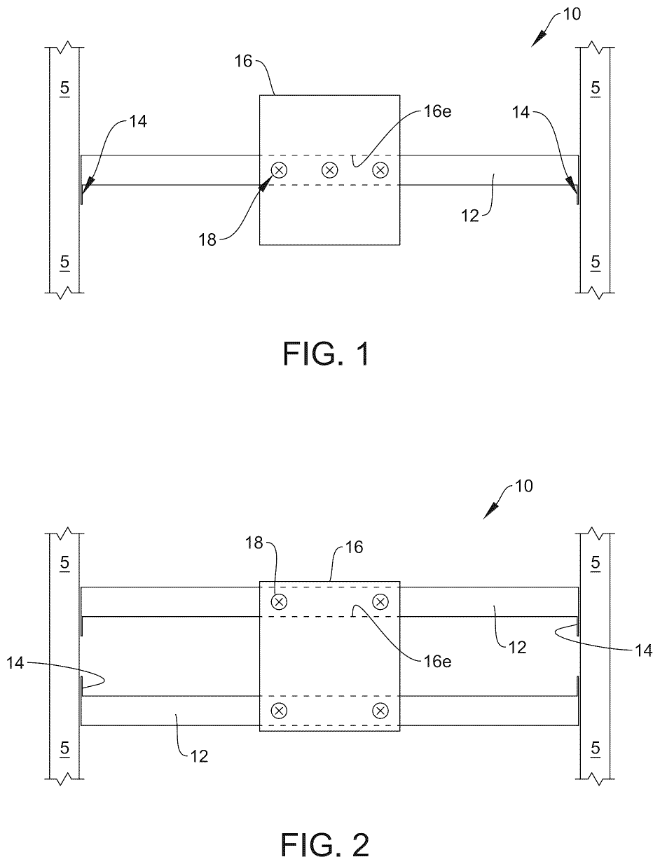

Referring now to FIGS. 1-5C, a universal control valve mounting assembly 10 is described and depicted. The assembly 10 comprises a crossmember 12 traversing between opposing studs (S) within a wall, the crossmember 12 secured at opposing ends to the opposing studs (S) via end brackets 14 having apertures 15a formed therethough. The crossmember 12 carries and sustains a support plate 16 coupled to the crossmember 12 and laterally (horizontally) adjustable along the length of the crossmember 12.

The crossmember 12 may comprise a variety of forms or shapes. It is envisioned that the crossmember 12 may comprise a linearly elongated shaft or bar with brackets 14 formed or disposed at opposing ends of the shaft or bar crossmember 12. The shaft or bar may comprise various configurations including forms having a cylindrical, triangular, and/or orthogonal cross-section. It is further envisioned that the crossmember 12 may comprise various materials, including durable forms of metal, thermoplastics, polyethylene, and other similar suitable materials.

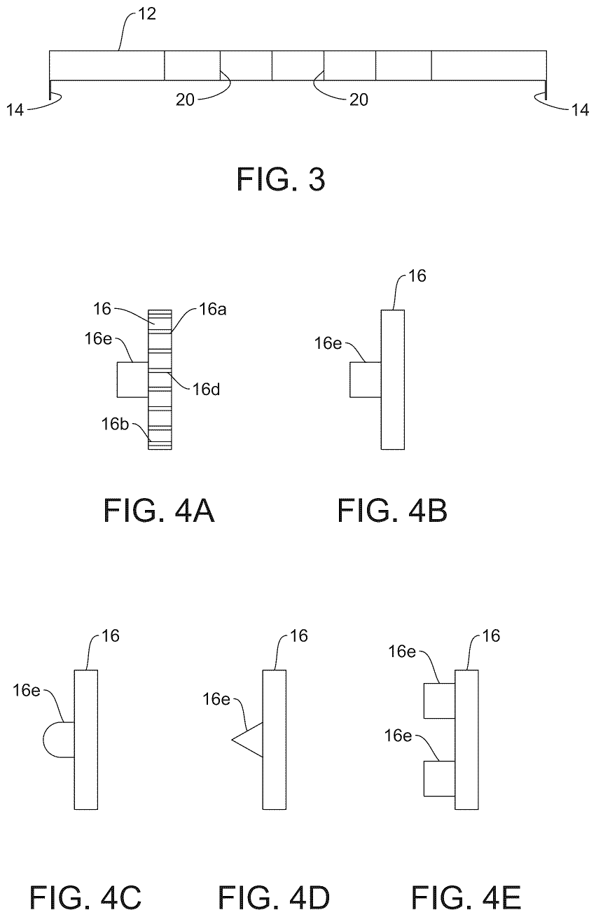

As illustrated in FIG. 3, the crossmember 12 may include defined separation points 20 along its length. Spacing between studs (S) can vary between 10 inches to 22 inches. Accordingly, the length of the crossmember 12 may be scored with indicia 20 defining such points of separation in a manner that allows the user to easily measure and remove segments as desired. In particular, it is envisioned that the indicia 20 may be scored approximately every two inches to provide significant variability in the crossmember 12 length. The scoring of indicia 20 is achieved with compromising the durability, stability, and mechanical integrity of the crossmember 12.

In one embodiment, the crossmember 12 is formed through joining or coupling of two smaller crossmember 12 segments. In such an embodiment, a single crossmember 12 segment is approximately 12 inches in linear length with multiple two-inch indicia 20 scored thereon. Therefore, for a 10 inch interval spacing between studs S, a 12-inch crossmember 12 may be altered by removing between two and four inches of the linear length and yielding a linear length that is adjustable for 10 inch to 14 inch interval spacing (and may be defined as approximately an eight inch universal mounting assembly 10). Similarly, for interval spacing between studs S ranging from 14 inches to 22 inches, two 12-inch crossmembers 12 may be altered by removing approximately even length segments from each of the two crossmembers 12 and using the support plate 16 and its complementary sleeve(s) 16c as a coupling means, with the fasteners 18 used to affix the support plate 16 to the separate crossmember 12 segments.

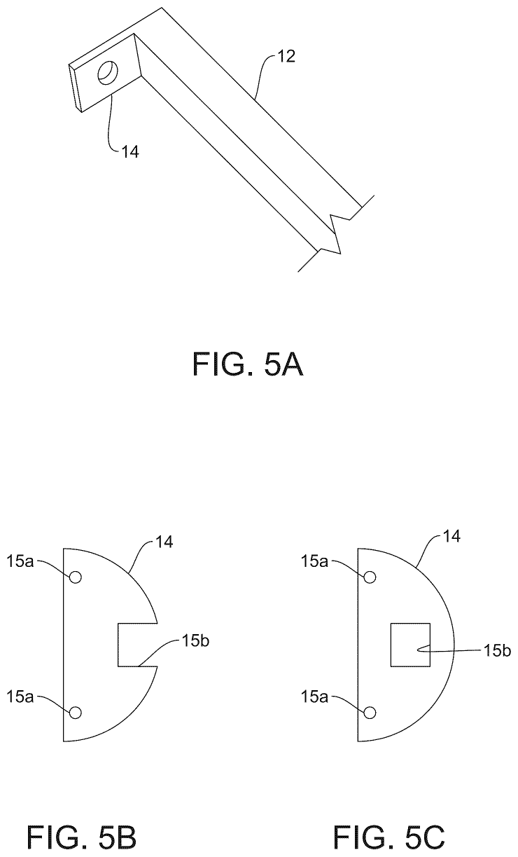

Consistent with FIGS. 1 and 2, and FIGS. 5A, 5B, and 5C, the bracket(s) 14 are disposed at the ends of the crossmember(s) 12. Each bracket 14 includes one or more apertures through which a mechanical fastener may be inserted therethrough to form a non-permanent joint between the crossmember(s) 12 through the bracket(s) 14 and apertures into the inside surface of a stud S within a wall. In one embodiment, consistent with FIG. 5A, the bracket(s) 14 is/are extended panels depending from the ends of the crossmember(s) 12 with apertures preformed therethrough for insertion/driving of mechanical fasteners to form the non-permanent joint between stud S and crossmember(s) 12. In another embodiment, consistent with FIG. 5B, the bracket(s) 14 is a separate element from the crossmember 12 and its linear elongated shaft or bar. In such an embodiment, the bracket 14 may have a variety of geometric or polygonal forms sufficient to provide one or more apertures for insertion or driving of mechanical fasteners, and with a recess 15b formed therein to receive, accommodate, support, and house the shaft or bar of the crossmember 12. As depicted in FIG. 5B, the recess 15b may be formed such that it includes an open side for setting the shaft or bar into the recess. Alternatively, as depicted in FIG. 5C, the recess 15b may be fully enclosed on all sides so that the shaft or bar must be inserted therein along its end. In particular, such embodiments would facilitate installation by first placing the brackets 14 in mechanical communication with the crossmember 12 by aligning the recess 15b with the shaft or bar of the crossmember 12 and then placing the arrangement between the studs S for installation via fasteners through apertures 15a.

Generally, consistent with FIG. 4A, the support plate 16 comprises a planar plate body 16c having an obverse surface 16a and a reverse surface 16b and having a plurality of perforations 16d formed therein. The body 16c defines a thickness that separates the obverse surface 16a from the reverse surface 16b and defines the depth of the perforation(s) 16d. The body 16c has at least one sleeve 16e formed or disposed along the reverse surface 16b, the at least one sleeve 16e dimensioned to accommodate the crossmember 12 therethrough.

In one embodiment of the support plate 16, particularly illustrated in FIGS. 4B through 4D, the body 16c comprises a sleeve 16e formed or disposed along the reverse surface 16b, the sleeve 16e formed or disposed approximately intermediate to the top margin and the bottom margin of the support plate 16. In another embodiment of the support plate 16, particularly illustrated in FIG. 4E, the body 16c comprises a plurality of sleeves 16e formed or disposed along the reverse surface 16b, the plurality of sleeves 16e formed or disposed adjacent the top margin and adjacent the bottom margin of the support plate 16. It is also envisioned that in another embodiment of the support plate 16, the body 16c comprises a sleeve 16e formed or disposed along the reverse surface 16b, the sleeve 16e formed or disposed adjacent the top margin of the support plate 16. It is also envisioned that in another embodiment of the support plate 16, the body 16c comprises a sleeve 16e formed or disposed along the reverse surface 16b, the sleeve 16e formed or disposed adjacent the bottom margin of the support plate 16.

Consistent with FIGS. 4B through 4D, it is envisioned that the sleeve 16e comprises a configuration, form, and/or orientation that accommodates the cross-sectional shape or configuration of the crossmember 12. In particular, the interior configuration or orientation of the sleeve 16e complements the exterior configuration or orientation of the crossmember 12. With this particular complementary union, the support plate 16 may be positioned and repositioned through lateral (horizontal) movement of the sleeve 16e relative to the crossmember 12. Once the desired position and/or location of the support plate 16 is achieved, the support plate 16 may be secured to the crossmember 12.

The support plate 16 may be secured to the crossmember 12 via one or more fasteners 18 inserted through one or more perforations 16d in the body 16c. It is envisioned that removable fasteners 18 may be utilized, including a variety of screws and/or bolts. It is also envisioned that semi-fixed fasteners 18 may be utilized, including screw anchors with screws or set-screws. Other similar articles, mechanisms, and/or means may be utilized for forming a non-permanent joint.

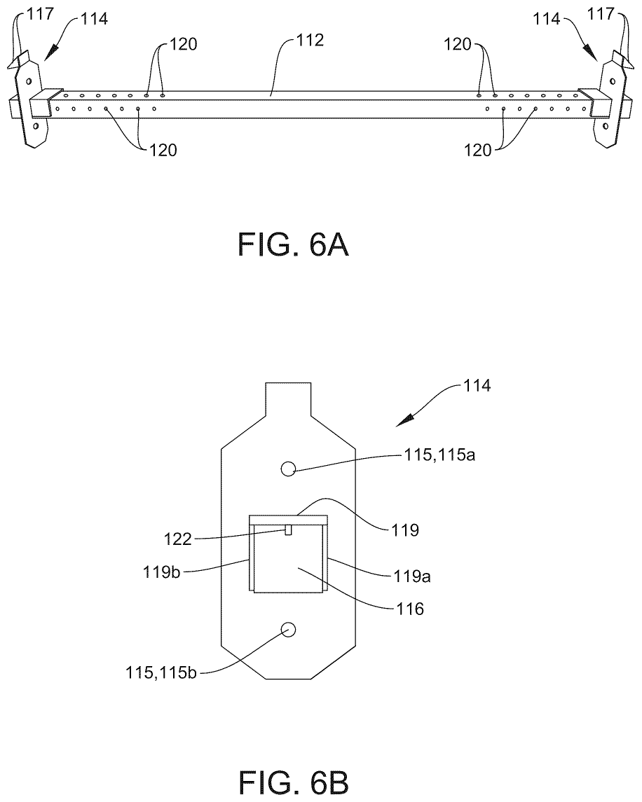

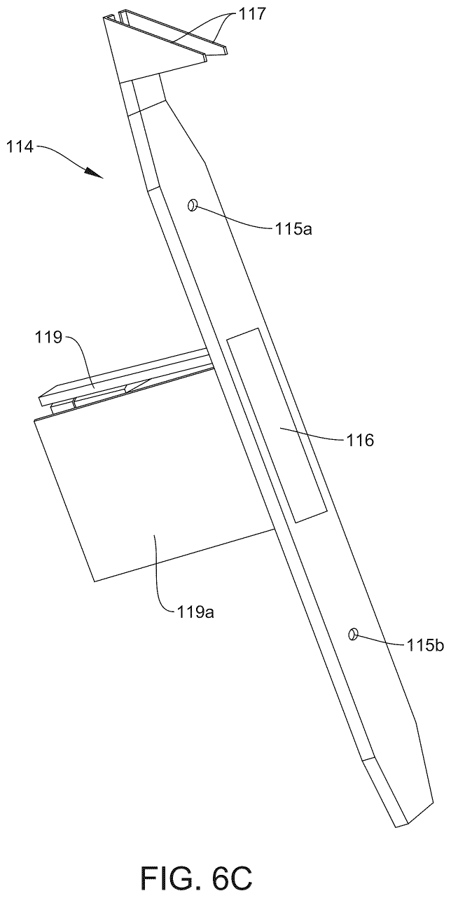

Referring now to FIGS. 6A-6C, in accordance to another embodiment, at least one crossmember 112 is secured at opposing ends thereof to opposing studs S via end brackets 114. Each end bracket 114 comprises a generally oblong shape and a receiving hole 116 for receiving a respective end of the crossmember 112. The brackets 114 each include apertures 115 formed therethough for receiving a fastener 18. A first aperture 115a is disposed above the receiving hole 116 and a second aperture 115b is disposed below the receiving hole 116.

A pair of teeth 117 project integrally rearwardly from an upper end of each bracket 114. The teeth 117 are partially pushed or driven into a respective stud S. The teeth 117 allow for the bracket 114 to be partially secured to stud S, thereby maintaining the crossmember 112 in position temporarily, should user decide to change position of the crossmember 112.

At least one of the brackets 114 includes an upper flap 119, a left flap 119a and a right flap 119b projecting integrally about a perimeter of the receiving hole 116 from a front side of the bracket and forming a guide for receiving an end of the crossmember 112. In a resting position, the upper flap 119 is biased downwardly, and the left flap 119a and the right flap 119b are biased inwardly toward the crossmember 112. At least one of the upper flap 119, left flap 119a, and right flap 119b includes a probe 122 projecting perpendicularly from an inner surface thereof and adapted to be received selectively within one of a series of linearly-aligned receiving apertures 120 defined through a respective sidewall of the crossmember 112, thereby detachably securing the crossmember to the brackets 114.

As previously described, the at least one crossmember 112 carries and sustains a support plate 16 coupled thereto and being laterally (horizontally) adjustable along the length of the crossmember 112. Further, as previously described and illustrated, a plurality of crossmembers 112 may carry and sustain a support plate 16 coupled thereto and being laterally (horizontally) adjustable along the lengths of the crossmembers 112.

Once installed, the assembly 10 forms the carrier and support for a valve control device, such as a faucet or shower head. The assembly 10 provides a substrate to which the valve control device can be mounted and fixed for the lifespan of the device.

It is to be understood that the embodiments and claims are not limited in its application to the details of construction and arrangement of the components set forth in the description and illustrated in the drawings. Rather, the description and the drawings provide examples of the embodiments envisioned, but the claims are limited to the specific embodiments. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the U.S. Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. It is intended that the application is defined by the claims appended hereto.

What is claimed is:

1. A universal control valve mounting assembly comprising:
a crossmember traversing between opposing studs within a wall, the crossmember secured at opposing ends to the opposing studs via end brackets having apertures formed therethough;
a support plate coupled to the crossmember and laterally adjustable along a length of the crossmember, the support plate comprising a plurality of perforations; and
a set screw coupling the support plate to the crossmember, the set screw penetrating at least one perforation and mechanically engaging the crossmember.

2. The assembly of claim 1, wherein the crossmember comprises a plurality of indicia designating length and scored for removing a defined segment of the crossmember.

3. The assembly of claim 1, wherein the support plate comprises a sleeve having a complementary interior dimension for receiving and accommodating an exterior dimension of the crossmember.

4. A universal control valve mounting assembly comprising:
a crossmember traversing between opposing studs within a wall, the crossmember secured at opposing ends to the opposing studs via end brackets having apertures formed therethough;
a support plate coupled to the crossmember and laterally adjustable along a length of the crossmember, the support plate coupled to the crossmember via a sleeve disposed on a reverse surface of the support plate, support plate comprising a
plurality of perforations; and
a set screw coupling the support plate to the crossmember, the set screw penetrating at least one perforation and mechanically engaging the crossmember.

5. The assembly of claim 4, the crossmember comprising a plurality of indicia designating length and scored for removing a defined segment of the crossmember.

6. The assembly of claim 4, the crossmember comprising a linearly elongated shaft.

7. The assembly of claim 6, the crossmember comprising a cylindrical cross-section.

8. The assembly of claim 6, the crossmember comprising a triangular cross-section.

9. The assembly of claim 6, the crossmember comprising an orthogonal cross-section.

10. The assembly of claim 4, the sleeve comprising an interior dimension complementary to an exterior dimension of the crossmember.

11. The assembly of claim 4, wherein each one of the brackets further comprises a recess supporting an end of the crossmember.

12. A universal control valve mounting assembly comprising:
a crossmember traversing between opposing studs within a wall, the crossmember secured at opposing ends thereof to the opposing studs via end brackets having apertures formed therethough;
end brackets detachably secure the crossmember at opposed ends respectively thereof to the opposing studs, the end brackets each having a receiving hole for receiving a respective end of the crossmember, and wherein the end brackets each includes a plurality of apertures formed therethough for receiving a fastener;
a support plate coupled to the crossmember and laterally adjustable along a length of the crossmember, the support plate comprising a plurality of perforations;
a sleeve disposed along a reverse surface of the support plate, the sleeve comprising an interior dimension complementary to an exterior dimension of the crossmember; and
a set screw coupling the support plate to the crossmember, the set screw penetrating at least one perforation and mechanically engaging the one or more crossmembers.

13. The assembly of claim 12, wherein the crossmember further comprises a first crossmember and a second crossmember.

14. The assembly of claim 13, wherein each the first crossmember and the second crossmember comprises a plurality of indicia designating length and scored for removing a defined segment of the first crossmember and the second crossmember.

15. The assembly of claim 13, wherein the first crossmember and the second crossmember are coupled via the sleeve, wherein the coupling of the first crossmember and the second crossmember define a substantially continuous single crossmember.

16. The assembly of claim 13, wherein the first crossmember and the second crossmember are positioned at different elevations.

17. The assembly of claim 16, wherein the support plate comprises a second sleeve along a reverse surface of the support plate, wherein the first sleeve and the second sleeve are disposed at different elevations, and wherein the first sleeve is disposed to complement the first crossmember and the second sleeve is disposed to complement the second crossmember.

18. The assembly of claim 17, wherein the support plate further comprises at least one set screw for the first sleeve and the first crossmember and at least one set screw for the second sleeve and the second crossmember.

19. The assembly of claim 12, wherein each one of the end brackets further comprises a pair of teeth projecting integrally rearwardly from an upper end thereof, and wherein the plurality of apertures comprises first aperture disposed above the receiving hole and a second aperture disposed below the receiving hole.

20. The assembly of claim 12, wherein at least one of the end brackets comprises an upper flap, a left flap, and a right flap projecting integrally about a perimeter of the receiving hole from a front side of the at least one end bracket, the upper flap, the left flap, and the right flap forming a guide for receiving an end of the crossmember.
